(19) United States
(12) Patent Application Publication
(10) Pub. No.: US 2025/0182385 A1
(43) Pub. Date: Jun. 5, 2025

(54) IMAGE STREAMING METHOD AND DEVICE FOR STREAMING POINT CLOUD-BASED CONTENT

(71) Applicant: Korea Electronics Technology Institute, Seongnam-si (KR)

(72) Inventors: Woo Chool PARK, Incheon (KR); Jun Hwan JANG, Goyang-si (KR); Jin Wook YANG, Uijeongbu-si (KR); Min Su CHOI, Seoul (KR); Jun Suk LEE, Seoul (KR); Bon Jae KOO, Suwon-si (KR)

(73) Assignee: Korea Electronics Technology Institute, Seongnam-si (KR)

(21) Appl. No.: 19/047,118

(22) Filed: Feb. 6, 2025

Related U.S. Application Data
(63) Continuation of application No. PCT/KR2022/017956, filed on Nov. 15, 2022.

(30) Foreign Application Priority Data
Aug. 9, 2022 (KR) 10-2022-0099073

(51) Int. Cl. G06T 15/20; G06T 9/00

(52) U.S. Cl. CPC G06T 15/205; G06T 9/00; G06T 2210/56

(57) ABSTRACT

Disclosed herein are a method and apparatus for point cloud video streaming. According to an embodiment, the method for point cloud video streaming may include receiving pose information from a user terminal changing the pose of a virtual camera in a virtual space where a point cloud video is played, by applying the pose information to the virtual camera, rendering an image texture of the point cloud video corresponding to a viewpoint of the virtual camera with the changed pose and transmitting video data with the rendered image texture to the user terminal.

### CROSS REFERENCE TO RELATED APPLICATION

The present application is based on International Patent Application No. PCT/KR2022/017956 filed on Nov. 15, 2022, which claims priority to a Korean patent application No. 10-2022-0099073 filed on Aug. 9, 2022, the entire contents of which are incorporated herein for all purposes by this reference.

### TECHNICAL FIELD

The present disclosure relates to a point cloud video streaming technology, and more particularly, to a video streaming method and apparatus for point cloud-based video or content streaming.

### BACKGROUND

Recently, there have been active efforts to improve the quality of activities and consumed content occurring in virtual spaces, including the metaverse and similar environments. This is because most of the existing metaverse or virtual space-based content has been primarily created with simple computer graphics, making them difficult to appeal to adults or be used for industrial purposes. As a result, it has mainly been sold as fragmentary cultural content or consumable entertainment content. To create a true metaverse that connects the real world with Extended Reality (XR) spaces, technology that can replicate the real world in the virtual world is essential, and digital twin technology is particularly suitable for this purpose.

Digital twins are primarily created using point clouds, and the methods for generating point clouds may be broadly condensed into two main approaches: using LiDAR (Light Detection and Ranging) or using vision cameras. Digital twins using point clouds are gaining attention for their ability to replicate the real world in the virtual world with remarkably high accuracy.

The issue is that reconstructing 3D objects based on point clouds consumes significant computing power, and since the data itself is also quite large, compression technology for this purpose is extremely important. Due to the complexity of compression technology, a technical standard has recently been established. Typical XR devices absolutely lack the computing power necessary to process point clouds, and realistically, it is expected to take considerable time before high-performance chips or user devices capable of adequately handling this emerge. However, to stimulate the metaverse market and promote the use of digital twin virtual spaces in the near future, technology that allows XR devices to receive and play point cloud-based digital twin content via streaming is necessary.

### SUMMARY

The technical problem of the present disclosure is to provide a video streaming method and apparatus for point cloud-based video or content streaming.

The technical problems solved by the present disclosure are not limited to the above technical problems and other technical problems which are not described herein will be clearly understood by a person having ordinary skill in the technical field, to which the present disclosure belongs, from the following description.

According to the present disclosure, a method for point cloud video streaming, the method may include receiving pose information from a user terminal, changing the pose of a virtual camera in a virtual space where a point cloud video is played, by applying the pose information to the virtual camera, rendering an image texture of the point cloud video corresponding to a viewpoint of the virtual camera with the changed pose and transmitting video data with the rendered image texture to the user terminal.

According to the embodiment of the present disclosure in the method, wherein the method receives inertial measurement unit (IMU) information of the user terminal.

According to the embodiment of the present disclosure in the method, wherein the method receives a pose matrix including the pose information from the user terminal, and wherein the changing of the pose of the virtual camera obtains a location coordinate value, yaw information, pitch information and roll information of the user terminal from the pose matrix and changes the pose of the virtual camera by applying the location coordinate value, the yaw information, the pitch information and the roll information to the virtual camera.

According to the embodiment of the present disclosure in the method, wherein the method further comprising, when point cloud data corresponding to the point cloud video is received, playing the point cloud video in the virtual space by decoding and rendering a video of each of channels included in the point cloud data.

According to the present disclosure, a apparatus for point cloud video streaming, the apparatus may include a reception unit configured to receive pose information from a user terminal, a pose control unit configured to change a pose of a virtual camera in a virtual space where a point cloud video is played, by applying the pose information to the virtual camera, a rendering unit configured to render an image texture of the point cloud video corresponding to a viewpoint of the virtual camera with the changed pose and a transmission unit configured to transmit video data with the rendered image texture to the user terminal.

According to the embodiment of the present disclosure in the apparatus, wherein the reception unit is further configured to receive inertial measurement unit (IMU) information of the user terminal.

According to the embodiment of the present disclosure in the apparatus, wherein the reception unit is further configured to receive a pose matrix including the pose information from the user terminal, and wherein the pose control unit is further configured to obtain a location coordinate value, yaw information, pitch information and roll information of the user terminal from the pose matrix and change the pose of the virtual camera by applying the location coordinate value, the yaw information, the pitch information and the roll information to the virtual camera.

According to the embodiment of the present disclosure in the apparatus, wherein the rendering unit is further configured to, when point cloud data corresponding to the point cloud video is received, play the point cloud video in the virtual space by decoding and rendering a video of each of channels included in the point cloud data.

According to the present disclosure, a system for point cloud video streaming, the system may include a rendering server and a user terminal, wherein the user terminal is configured to measure pose information of the user terminal and transmit the pose information to the rendering server, and wherein the rendering server is configured to receive the pose information from the user terminal, change a pose of a virtual camera in a virtual space where a point cloud video is played, by applying the pose information to the virtual camera, render an image texture of the point cloud video corresponding to a viewpoint of the virtual camera with the changed pose, and transmit video data with the rendered image texture to the user terminal.

According to the embodiment of the present disclosure in the system, wherein the rendering server is further configured to, when point cloud data corresponding to the point cloud video is received, play the point cloud video in the virtual space by decoding and rendering a video of each of channels included in the point cloud data.

The various beneficial advantages and effects of the present disclosure are not limited to the foregoing, and will be more readily understood in the course of describing specific embodiments of the present disclosure.

The present disclosure is technically directed to providing a video streaming method and apparatus for point cloud-based video or content streaming.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 shows a configuration of a video streaming system according to an embodiment of the present disclosure.

FIG. 2 shows a configuration of an embodiment for the rendering server illustrated in FIG. 1.

FIG. 3 is a view showing an example of a detailed structure of a rendering server for describing an operation in the rendering server.

FIG. 4 is a view showing an example for describing a pose change of a virtual camera according to pose information of a user terminal.

FIG. 5 is a view showing an example of a point cloud video rendered in a virtual space.

FIG. 6 is a view showing an example of video obtained by a virtual camera.

FIG. 7 shows an operation flowchart of a video streaming method according to another embodiment of the present disclosure.

FIG. 8 shows a configuration of a device to which a video streaming apparatus is applied according to another embodiment of the present disclosure.

### DESCRIPTION OF THE PREFERRED EMBODIMENTS

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

In the present disclosure, expressions of spatial relationships used in this specification, such as “upper,” “lower,” “left,” “right,” etc., are provided for convenience of description. In the event that the drawings described herein are viewed in the reverse orientation, the spatial relationships as described in the specification may be interpreted in the opposite direction.

In the present disclosure, phrases such as “A or B,” “at least one of A and B,” “at least one of A or B,” “A, B, or C,” “at least one of A, B, or C,” and “at least one of A, B, or C” are each intended to encompass any one of the listed items, or any possible combination of them.

The content reproduction space broadly refers to a space where content is registered and displayed, and it has different characteristics and limitations depending on each XR (VR, AR, MR) technology.

Spaces currently discussed as metaverse spaces are all VR (Virtual Reality) environments, which have a fixed-size world and refer to spaces where all environments are artificially created. When enjoying VR content, users are visually completely disconnected from the real world, and changes in the external world do not affect the content being played.

Augmented reality (AR) plays virtual content by ‘overlaying’ virtually created object-based content from the user's perspective, superimposing it on the real world. Through basic object recognition, the position where the content is played may change, but it is not fully mixed with the real world.

Mixed reality (MR) similarly plays virtually created object content, but it reproduces the content in harmony with the real world visible from the user's perspective. When MR content is played, first, a transparent virtual space with its own coordinate system is created, corresponding to the real world from the user's perspective. Once the virtual space is created, virtual content is placed within it. The appearance of this content changes according to the real-world environment, becoming mixed with the real world.

The embodiments of the present disclosure essentially aim to enable the playback of point cloud-based content on user XR devices by utilizing existing commercial 3D engines to render point cloud content in real-time within a virtual space and transmit it to XR devices, allowing users to enjoy point cloud content with minimal computing power.

In other words, the embodiments of the present disclosure enable the viewing of point cloud-based videos, which typically require high-performance computing resources, on widely distributed existing terminals or lightweight user devices (or user terminals).

The point cloud-based streaming according to these embodiments of the present disclosure may be utilized in all XR domains because it reproduces content centered on objects. However, in the case of MR, there is a constraint that a spatial environment for playing content should be digitally pre-configured.

Briefly speaking, point clouds refer to data collected by sensors such as LiDAR and RGB-D sensors. These sensors send light/signals to objects and record the time it takes for them to return, calculating distance information for each light/signal, and generating a single point. A point cloud means a set cloud of multiple points spread in a 3D space.

Unlike 2D images, point clouds have depth (z-axis) information, so they are fundamentally represented as an N×3 NumPy array. Here, each row of N is mapped to a single point and contains information of 3 (x, y, z) coordinates.

A technology of playing or enjoying such point cloud-based content, that is, video content on lightweight user terminals with minimal computing power may be described as follows.

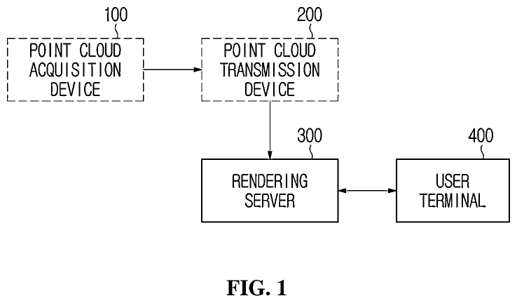

FIG. 1 shows a configuration of a video streaming system according to an embodiment of the present disclosure.

Referring to FIG. 1, a video streaming system according to an embodiment of the present disclosure includes a point cloud acquisition device 100, a point cloud transmission device 200, a rendering server 300 and a user terminal 400.

In case a point cloud video to be provided by a rendering server is played from a local file within the rendering server 300, the point cloud acquisition device 100 and the point cloud transmission device 200 are not required in the system configuration. In this case, the rendering server 300 and the user terminal 400 are sufficient for a service. Of course, the rendering server 300 may store and use a pre-compressed point cloud video because of capacity issue.

The point cloud acquisition device 100 refers to a device that collects raw data of point cloud content to be played in the user terminal 400.

Herein, the point cloud acquisition device 100 may obtain point clouds by using a device for obtaining point clouds, such as Azure Kinect of Microsoft, or obtain point clouds from real objects by using a RGB camera.

Point clouds may be obtained from virtual objects through a 3D engine, and any type of captured objects, whether they are real objects or virtual objects created by CG, is ultimately made into a point cloud video format. However, because a real object is captured from its every face, it is normally captured by one or more cameras. A point cloud acquisition device obtains a video in a raw format, which results in a large-capacity output.

The point cloud transmission device 200 is a device that transmits point cloud video data obtained by the point cloud acquisition device 100 to the rendering server 300. It transmits compressed point cloud video data to the rendering server 300 via a network device.

Herein, the point cloud transmission device 200 may be a single server or PC.

That is, the point cloud transmission device 200 may receive point cloud video data in a raw format as input and output a compressed point cloud video to the rendering server 300.

Compression of a point cloud video requires a highly advanced technology and a high specification system. Because the compression methods and technology for point cloud videos are obvious to those skilled in the art, no detailed description will be provided.

According to an embodiment, in case point cloud data is obtained by diverse point cloud acquisition devices 100, the point cloud transmission device 200 may synchronize the point cloud data obtained from the diverse point cloud acquisition devices and then create a single compressed point cloud video.

Corresponding to a video streaming apparatus according to an embodiment of the present disclosure, the rendering server 300 plays a point cloud video in a virtual space by rendering a compressed point cloud video, receives pose information of the user terminal 400 from the user terminal 400, renders a point cloud video corresponding to the pose information, and transmits a point cloud video corresponding to the rendered pose information, for example, a 2D video to the user terminal 400.

Herein, the rendering server 300 may receive pose information of the user terminal 400 in inertial measurement unit (IMU) information measured by the user terminal 400, change a pose of a virtual camera by applying the pose information to the virtual camera in a virtual space where a point cloud video is played, render an image texture of a point cloud video corresponding to a viewpoint of the virtual camera with the changed pose, and transmit video data with the rendered image texture to the user terminal 400.

That is, the rendering server 300 may receive, for input data, three types of compressed point cloud videos (color, geometry and occupancy) and IMU information of the user terminal 400 and output, for output data, a 2D video from a user terminal viewpoint corresponding to the IMU information.

Herein, the rendering server 300 may store a compressed point cloud video in the form of local file or receive a compressed point cloud video from the point cloud transmission device 200.

The user terminal 400 measures and transmit pose information of the user terminal to the rendering server 300 and receives and displays video data corresponding to the pose information of the user terminal from the rendering server 300.

Herein, the user terminal 400 may measure IMU information of the user terminal by using an IMU sensor and transmit the measured IMU information to the rendering server 300.

The user terminal 400 may include not only glasses, a headset or smart phone but also all other terminals to which a technology according to an embodiment of the present disclosure is applicable and should have a hardware decoder for quickly decoding a 2D video, a display for showing a video, an IMU sensor for obtaining raw data of a pose of a device, and a network device for transmitting IMU information.

Herein, the network device may include every network capable of performing communication with the rendering server 300 and include a device for accessing a cellular network (LTE, 5G) and a device for accessing Wi-Fi, for example. Of course, the network device may include not only devices with the functions but also every network device that is applicable to this technology.

The user terminal 400 may be configured such that an input does not determine an output but the output determines a next input.

According to an embodiment, the user terminal 400 obtains values for a location of the user terminal and a rotation matrix through an IMU sensor embedded in the user terminal 400. Herein, a coordinate system may depend on a system for processing corresponding data. For example, an Android smartphone may depend on the coordinate system of OpenGL.

The user terminal 400 may use a location of the user terminal and a rotation matrix obtained by the IMU sensor to construct a single 4×4 matrix, which may be expressed by Formula 1 below.

$$[ \begin{matrix}{R}_{11} & {R}_{12} & {R}_{13} & {T}_{1} \\ {R}_{21} & {R}_{22} & {R}_{23} & {T}_{2} \\ {R}_{31} & {R}_{32} & {R}_{13} & {T}_{3} \\ 0 & 0 & 0 & 1\end{matrix} ] \qquad [ Formula 1 ]$$

Here, R₁₁˜R₃₃ may mean a rotation matrix of the user terminal, and T₁˜T₃ may mean coordinates representing a location of the user terminal in a 3D space.

Each element of each matrix is 4 byte-sized data in float form, and one matrix may have a total size of 64 bytes. Each time a pose matrix is obtained, the user terminal may capsulate data and transmit it to the rendering server.

Herein, the data may be configured as a byte-type array, as shown in Table 1 below.

TABLE 1

| | |
|---|---|
| size(4) | body(64) |

In Table 1 above, first 4 bytes of transmitted data are a field unconditionally representing a size of body data, and the next body has as large data as defined in the size field. For example, because a pose matrix has a size of 64 bytes, a 4 byte-size value indicating 64 bytes is prefixed to 64-byte matrix data.

The user terminal 400 transmits the data to the rendering server 300 according to a transmission scheme defined in a system. Herein, the user terminal may transmit the data by using a raw socket in a TCP scheme for fast transmission of the pose matrix and transmit the data by using a QUIC protocol transmission method in a UDP scheme.

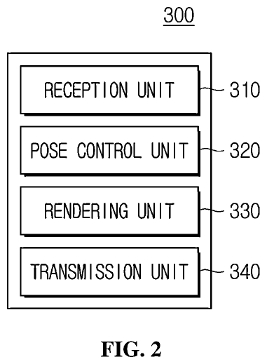

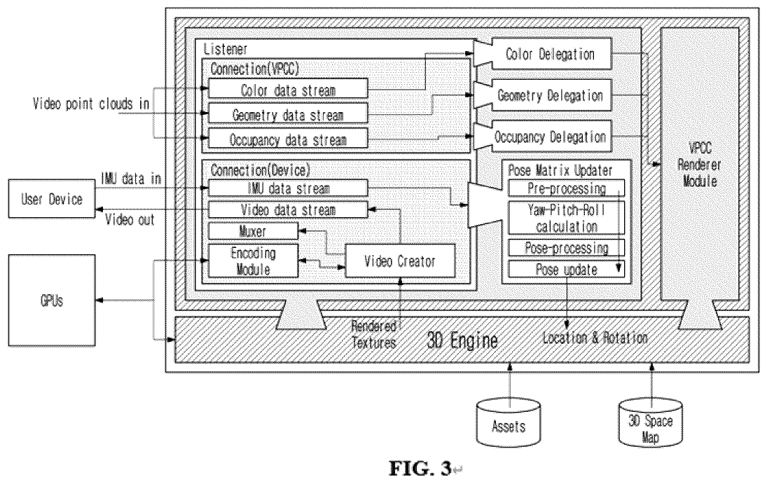

FIG. 2 shows a configuration of an embodiment for the rendering server illustrated in FIG. 1, and FIG. 3 is a view showing an example of a detailed structure of a rendering server for describing an operation in the rendering server, showing a configuration of a video streaming apparatus according to an embodiment of the present disclosure.

Referring to FIG. 2 and FIG. 3, the rendering server 300 includes a reception unit 310, a pose control unit 320, a rendering unit 330 and a transmission unit 340.

The reception unit 310 receives pose information from the user terminal 400 and receives point cloud video data when the point cloud video data is transmitted from a point cloud transmission device.

Herein, the reception unit 310 may receive IMU information (data) from the user terminal 400.

A pose control unit changes a pose of a virtual camera by applying pose information to the virtual camera in a virtual space where a point cloud video is played.

Herein, the pose control unit 320 may obtain a location coordinate value, yaw information, pitch information and roll information of a user terminal from a pose matrix of IMU information and change a pose of a virtual camera by applying the location coordinate value, the yaw information, the pitch information and the roll information to the virtual camera.

The rendering unit 330 renders an image texture of a point cloud video corresponding to a viewpoint of the virtual camera with the changed pose.

Furthermore, when point cloud data corresponding to a point cloud video is received from a point cloud transmission device, the rendering unit 330 may decode and render each video of channels included in the point cloud data such as a color data channel, a geometry data channel and an occupancy data channel, thereby reproducing the point cloud video in the virtual space.

The transmission unit 340 transmits video data with an image texture, which is rendered by the rendering unit 330, such as a 2D video, to the user terminal 400.

An operation of a rendering server including this configuration may be further described as follows. To create a video of a user perspective, the rendering server should apply pose matrix information delivered from a user terminal to a camera in a virtual space. That is, a virtual camera, which changes a user's perspective by following a pose of a user terminal, should be placed in a virtual space.

A virtual camera may be easily placed through a general 3D game engine (e.g., Unreal, Unity), and location coordinate values and yaw, pitch and roll information, which may be obtained from a pose matrix, are reflected in the virtual camera.

A rendering server may set a location by putting T₁, T₂ and T₃, which constitute a pose matrix, into X, Y and Z coordinate values respectively and calculate a yaw value, a pitch value and a roll value by using Formula 2 below.

[Formula 2]

```
If (R₁R₁ == 1.0 OR R₁R₁ == −1.0)
  Yaw = arctan(R_{12,} R₁₃)
  Pitch = 0
  Roll = 0
Else
  Yaw = arctan(R₃₁, R₁₁)
  Pitch = arcsin(R₂₁)
  Roll = arctan(R₂₃, R₂₂)
```

Here, because each value calculated by Formula 2 above is a radian, if those radians are converted into degrees, a direction in which a virtual camera is pointing may be determined in a 3D engine, and as each system has a different reference coordinate axis, such reference of axis may be suitably set.

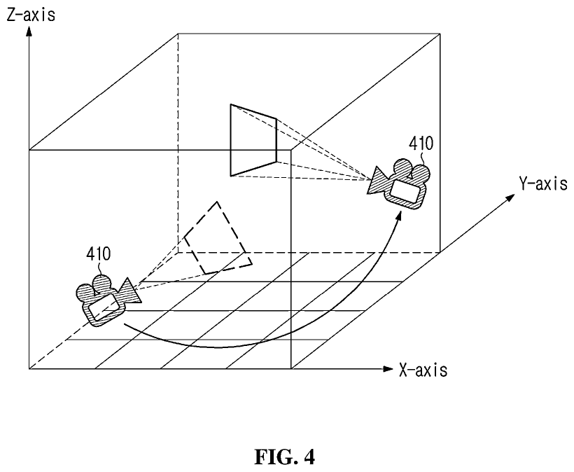

For example, as illustrated in FIG. 4, through pose information received from a user terminal, a rendering server changes a preset placement (or pose) of the virtual camera 410 to correspond to the pose information of the user terminal.

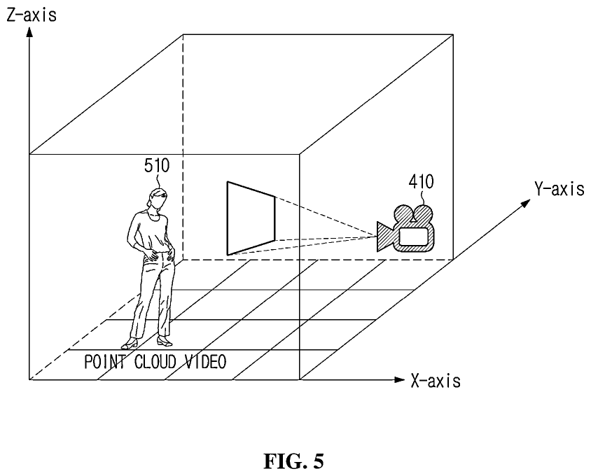

In addition, because a point cloud video is composed of a color, a geometry and an occupancy at each point, videos of a total of 3 channels should be reproduced simultaneously. In case a rendering server receives videos of 3 channels through a network, the rendering server receives and decodes all the videos and then performs rendering, and a point cloud video thus rendered is played in a 3D virtual space. For example, as illustrated in FIG. 5, a rendering server may receive a point cloud video and render a video of each channel, thereby playing a point cloud video 510 in a virtual space.

The rendering server may make a location and rotation structure or set based on values obtained through pose information of a user terminal, change a pose of a virtual camera placed in a 3D engine by applying this information to the camera, and instruct a GPU to render an image texture viewed from the viewpoint of the camera.

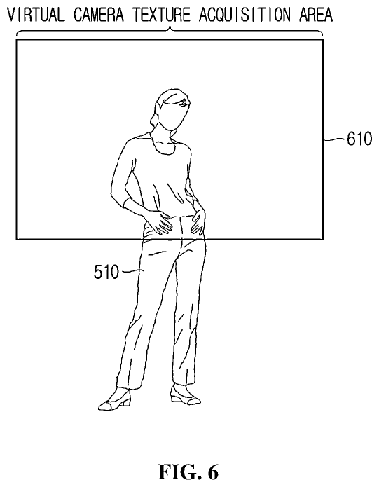

The image texture obtained from the GPU is compressed (or encoded) through a codec like H.264 and HEVC, and the compressed video is contained again in an appropriate file format (muxing) so that video data is finally generated. 2D video data thus generated is delivered to a user terminal through a communication interface, and the user terminal may display a 2D video corresponding to the pose information of the user terminal accordingly. For example, a rendering server may change a placement of the virtual camera 410 based on pose information of a user terminal, as illustrated in FIG. 5, render an image texture of the point cloud video 510, which is played in a virtual space, and thus generate a 2D video corresponding to a virtual camera texture acquisition area 610, as illustrated in FIG. 6. The rendering server delivers the generated 2D video of the virtual camera texture acquisition area 610 of FIG. 6 to the user terminal. This process is repeated in real time, and the user terminal may display a point cloud video accordingly.

Thus, a video streaming apparatus according to an embodiment of the present disclosure may enable the viewing of point cloud-based videos, which require high-performance computing resources, on widely distributed existing terminals or lightweight user devices.

In addition, the video streaming apparatus according to an embodiment of the present disclosure may accurately track and reflect a pose of the user terminal without relying on the previously used Visual Simultaneous Localization and Mapping (VSLAM) technology. By not utilizing VSLAM, the user terminal is required to send only IMU data, which reduces network overload, computational demands on the user terminal, and battery consumption.

In addition, a video streaming system according to an embodiment of the present disclosure may perform complex or variable computations on the rendering server, simplifying the software installed on the user terminal and increasing compatibility. By ensuring that the world coordinate systems used by the 3D engines on both the user terminal and the rendering server are aligned, it becomes possible to accurately track a pose.

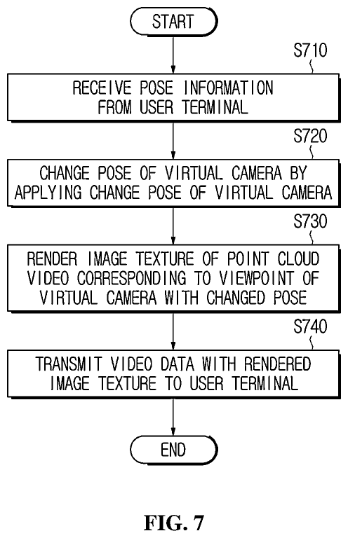

FIG. 7 shows an operation flowchart of a video streaming method according to another embodiment of the present disclosure, that is, the operation flowchart in the rendering server of FIG. 2.

Referring to FIG. 7, the video streaming method according to another embodiment of the present disclosure receives pose information from a user terminal and changes a pose of a virtual camera in a virtual space, where a point cloud video is played, by applying the pose information of the user terminal to the virtual camera (S710 and S720).

Herein, at step S710, IMU information of the user terminal may be received, and at step S720, a location coordinate value, yaw information, pitch information and roll information of the user terminal may be obtained from a pose matrix included in the IMU information, and a pose of the virtual camera may be changed by applying the location coordinate value, the yaw information, the pitch information and the roll information to the virtual camera.

When the pose of the virtual camera is changed at step S720, an image texture of a point cloud video corresponding to a viewpoint of the virtual camera with the changed pose is rendered, and video data with the rendered image texture, for example, a 2D video is transmitted to the user terminal (S730 and S740).

Furthermore, a point cloud video streaming method according to another embodiment of the present disclosure may also play a point cloud video in a virtual space by decoding and rendering a video of each channel included in point cloud data corresponding to the point cloud video, when the point cloud data is received.

Although not described in the method of FIG. 7, a method according to an embodiment of the present disclosure may include all the contents described in the apparatus or system described in FIG. 1 to FIG. 6, and this may be clearly understood by those skilled in the art.

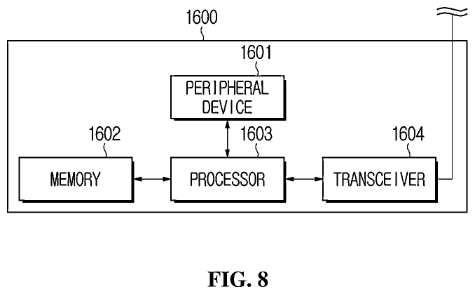

FIG. 8 shows a configuration of a device to which a video streaming apparatus is applied according to another embodiment of the present disclosure.

For example, the video streaming apparatus according to another embodiment of the present disclosure in FIG. 2 may be a device 1600 of FIG. 8. Referring to FIG. 8, the device 1600 may include a memory 1602, a processor 1603, a transceiver 1604, and a peripheral device 1601. Also, as an example, the device 1600 may additionally include other components and is not limited to the above-described embodiment. Herein, for example, the device 1600 may be a mobile user terminal (e.g., a smartphone, a laptop computer, a wearable device, etc.) or a fixed management device (e.g., a server, a personal computer (PC), etc.).

More specifically, the device 1600 of FIG. 8 may be an exemplary hardware/software architecture such as a content provision server, an extended video service server, and a point cloud video provision server. Herein, as an example, the memory 1602 may be a non-removable memory or a removable memory. Also, as an example, the peripheral device 1601 may additionally include a display, GPS or other peripheral devices but is not limited to the above-described embodiment.

For example, the device 1600 may include a communication circuit, such as the transceiver 1604, and communicate with an external device on the basis of the communication circuit.

In addition, as an example, the processor 1603 may be at least one of a general processor, a digital signal processor (DSP), a DSP core, a controller, a microcontroller, application-specific integrated circuits (ASICs), field programmable gate array (FPGA) circuits, different types of arbitrary integrated circuits (ICs), and one or more microprocessors related to a state machine. In other words, the processor 1603 may be a hardware/software component for controlling the device 1600. Also, the processor 1603 may modularize and execute the above-described functions of the pose control unit 320 and the rendering unit 330 of FIG. 2.

Herein, the processor 1603 may execute computer-executable instructions stored in the memory 1602 to implement various necessary functions of a video streaming apparatus. As an example, the processor 1603 may control at least any one of signal coding, data processing, power control, input/output processing and a communication operation. Also, the processor 1603 may control a physical layer, a media access control (MAC) layer, and an application layer. Also, as an example, the processor 1603 may perform an authentication and security procedure on an access layer, the application layer, etc. and is not limited the above-described embodiment.

As an example, the processor 1603 may communicate with other devices through the transceiver 1604. As an example, the processor 1603 may control a video streaming apparatus to perform communication with other devices via a network by executing computer-executable instructions. In other words, communication performed in the present disclosure may be controlled. As an example, the transceiver 1604 may transmit a radio frequency (RF) signal through an antenna and transmit a signal on the basis of various communication networks.

Also, as an example, as an antenna technology, a multiple-input multiple-output (MIMO) technology, beamforming, etc. may be used, and the antenna technology is not limited to the above-described embodiment. Also, a signal transmitted or received through the transceiver 1604 may be modulated or demodulated and controlled by the processor 1603 and is not limited to the above-described embodiment.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A point cloud video streaming method comprising:
receiving pose information from a user terminal:
changing the pose of a virtual camera in a virtual space where a point cloud video is played, by applying the pose information to the virtual camera;
rendering an image texture of the point cloud video corresponding to a viewpoint of the virtual camera with the changed pose; and
transmitting video data with the rendered image texture to the user terminal.

2. The point cloud video streaming method of claim 1, wherein the receiving the pose information comprises receiving inertial measurement unit (IMU) information of the user terminal.

3. The point cloud video streaming method of claim 1, wherein the receiving the pose information comprises receiving a pose matrix including the pose information from the user terminal, and
wherein the changing of the pose of the virtual camera obtains a location coordinate value, yaw information, pitch information and roll information of the user terminal from the pose matrix and changes the pose of the virtual camera by applying the location coordinate value, the yaw information, the pitch information and the roll information to the virtual camera.

4. The point cloud video streaming method of claim 1, further comprising, when point cloud data corresponding to the point cloud video is received, playing the point cloud video in the virtual space by decoding and rendering a video of each of channels included in the point cloud data.

5. A point cloud video streaming apparatus comprising:
a reception unit configured to receive pose information from a user terminal;
a pose control unit configured to change a pose of a virtual camera in a virtual space where a point cloud video is played, by applying the pose information to the virtual camera;
a rendering unit configured to render an image texture of the point cloud video corresponding to a viewpoint of the virtual camera with the changed pose; and
a transmission unit configured to transmit video data with the rendered image texture to the user terminal.

6. The point cloud video streaming apparatus of claim 5, wherein the reception unit is further configured to receive inertial measurement unit (IMU) information of the user terminal.

7. The point cloud video streaming apparatus of claim 5, wherein the reception unit is further configured to receive a pose matrix including the pose information from the user terminal, and
wherein the pose control unit is further configured to obtain a location coordinate value, yaw information, pitch information and roll information of the user terminal from the pose matrix and change the pose of the virtual camera by applying the location coordinate value, the yaw information, the pitch information and the roll information to the virtual camera.

8. The point cloud video streaming apparatus of claim 5, wherein the rendering unit is further configured to, when point cloud data corresponding to the point cloud video is received, play the point cloud video in the virtual space by decoding and rendering a video of each of channels included in the point cloud data.

9. A point cloud video streaming system comprising:
a rendering server; and
a user terminal,
wherein the user terminal is configured to measure pose information of the user terminal and transmit the pose information to the rendering server, and
wherein the rendering server is configured to:
receive the pose information from the user terminal, change a pose of a virtual camera in a virtual space where a point cloud video is played, by applying the pose information to the virtual camera,
render an image texture of the point cloud video corresponding to a viewpoint of the virtual camera with the changed pose, and
transmit video data with the rendered image texture to the user terminal.

10. The point cloud video streaming system of claim 9, wherein the rendering server is further configured to, when point cloud data corresponding to the point cloud video is received, play the point cloud video in the virtual space by decoding and rendering a video of each of channels included in the point cloud data.
